(19) United States
(12) Patent Application Publication
(10) Pub. No.: US 2003/0236974 A1
(43) Pub. Date: Dec. 25, 2003

(54) Content receiving and distributing system

(76) Inventors: Kiminori Sato, Osaka (JP); Akihiro Otsuki, Osaka (JP); Tatsuro Ishida, Osaka (JP); Kiyokazu Tohma, Osaka (JP); Kaoru Matsuoka, Osaka (JP)

Correspondence Address: RABIN & CHAMPAGNE, PC, 1101 14TH STREET, NW, SUITE 500, WASHINGTON, DC, 20005, US

(21) Appl. No.: 10/464,864

(22) Filed: Jun. 19, 2003

(30) Foreign Application Priority Data
Jun. 24, 2002 (JP) 2002-183554

(51) Int. Cl. H04L 9/00

(52) U.S. Cl. 713/153

(57) ABSTRACT

A content receiving and distributing system enables content to be received from or distributed to a user securely, simply, and promptly. The system includes a server that stores content data, a data receiving and distributing apparatus connected to the server, and a user terminal 15 linked to the data receiving and distributing apparatus via a network for receiving and distributing content data. A storage device provided in each of the data receiving and distributing apparatus and the user terminal stores a reception and distribution program required to receive and distribute content data. The reception and distribution program is stored simultaneously with the content data in the storage device provided in the user terminal. Content data is received and distributed on the basis of a user request input to the user terminal for downloading or uploading of content data from or to the data receiving and distributing apparatus.

This application incorporates by reference the entire disclosure of applicants' corresponding Japanese application, Ser. No. 2002-183554, filed Jun. 24, 2002, priority for which is claimed.

### FIELD OF THE INVENTION

The present invention relates to a content receiving and distributing system and, specifically, to a content receiving and distributing system that enables content to be received from or distributed to a user securely, simply, and promptly.

### BACKGROUND OF THE INVENTION

To obtain content such as video, music or software programs, a user utilizes either a method of directly visiting a content store to purchase an article on which the content desired by the user is recorded, or a method of downloading the desired content in the form of electronic data into the user's computer or the like via a communication network such as the Internet.

FIG. 6 is a diagram illustrating a first conventional business arrangement by which the user can obtain his or her desired content. This figure shows the flow of the processes performed by a content-managing company, a content store, and a user.

To obtain his or her desired content, the user 63 visits a content store 62 or inquires by phone of the content store 62 concerning the desired content. If the desired content is available at the store, the user 63 purchases a recording medium 67 on which the desired content is recorded. If the content is sold out, the user 63 places an order 64 with the content store 62. Upon receiving the order, the content store 62 places an order 65 with the content-managing company 61 for a medium on which the content corresponding to the contents of the order 64 is recorded.

The content-managing company 61 retrieves content data 66, which corresponds to the order 65, from content data recorded on a content-data recording device managed by the company. The content-managing company 61 then records the content data 66 on a recording medium 67 such as a CD or a DVD, and sells the recording medium 67 wholesale to the content store 62. The user 63 obtains the recording medium 67 by directly visiting the content store 62 or having the medium 67 delivered by a delivery company or the like. The user 63 inserts the recording medium 67 into the equipment of the user 63 such as a personal computer or audio-visual equipment, and installs the data into the equipment for his or her use.

FIG. 7 is a diagram illustrating the flow of consideration in the business transactions conducted in the above manner. The content-managing company 61 sells wholesale to the content store 62 the recording medium 67 on which the content is recorded, and receives a consideration 68 therefor. The content store 62 receives a consideration 69 by selling the user 63 the recording medium 67. Thus, the business arrangement is concluded.

FIG. 8 is a diagram illustrating a second conventional business arrangement by which the user obtains his or her desired content. This figure shows the flow of the processes performed by a content-managing company, a network provider and a user.

To obtain his or her desired content, the user 84 inputs a request command 85 for the desired content to a network terminal 83, such as a personal computer, connected to a network. The network terminal 83 transmits the request command 85 from the user 84 to a computer 81 managed by the content-managing company, via a computer 82 managed by the network provider. Upon receiving the request command 85, the computer 81 of the content-managing company transmits electronic data 86 representing the content corresponding to the request command 85, to the network terminal 83 via the network provider-managed computer 82. Then, the user receives the electronic data 86 and installs it in equipment owned by the user 84, such as a personal computer or audio-visual equipment.

FIG. 9 is a diagram illustrating the flow of consideration in the business arrangement conducted in the above manner. As consideration for the transmission by the content-managing company 91 of the content to the user's network terminal via the network provider 92, the user 93 pays a content charge 95 to the content-managing company 91. The user 93 also pays a network charge 96 to the network provider 92. Thus, the business arrangement is concluded.

However, in the content transaction according to the first conventional business arrangement, shown in FIG. 6, the costs involved and time required accrue disadvantageously in association with the movement of the recording medium 67 before the user 63 obtains the recording medium 67. A third party such as a transportation company, the content store 62, or the like intervene between the content-managing company 61 and the user 63 before the user 63 obtains the recording medium 67. Thus, disadvantageously, security is not guaranteed before the user 63 obtains the recording medium 67.

By contrast, in the content transaction according to the second conventional business arrangement shown in FIG. 8, the content is provided in the form of electronic data 86 so that, advantageously, lower costs and less time are associated with the movement of the content. Further, only the network provider 82 intervenes between the content-managing company 81 and the network terminal 83 of the user 84. That is, fewer third parties can intervene between them. However, if a malicious third person invades the network, the electronic data 86 for the content may be improperly accessed or altered. Consequently, the content may not be sold or purchased in a secure manner.

To solve these problems, it is contemplated that, for example, the electronic data 86 might be encrypted prior to transmission. However, in this case, the user 84 must be notified of the decryption method in advance. Thus, a new problem arises. Specifically, if such notification is carried out by the content-managing company 81 through the transmission of data about the decryption method to the network terminal 83 of the user 84 via the network, then it is difficult to ensure the security of the decryption method. On the other hand, if the user 84 is notified of the decryption method through a mailed document, for example, it may cause unnecessary problems for the user 84, by again necessitating a third party to intervene between the content-managing company 81 and the user 84. Consequently, security may be compromised.

### SUMMARY OF THE INVENTION

The present invention is provided in response to these problems. It is an object of the present invention to provide a content receiving and distributing system that enables content to be received from or distributed to a user securely, simply, and promptly.

In one aspect of the invention, a content receiving and distributing system comprises a server that stores content data, a data receiving and distributing apparatus connected to the server, and a user terminal for receiving content data from and distributing content data to the server, the user terminal being adapted for downloading content data from or uploading content data to the data receiving and distribution apparatus via a network in response to a user request. In the inventive system, each of the data receiving and distributing apparatus and the user terminal stores the reception and distribution program required to receive and distribute content data, and, in the user terminal, the reception and distribution program is stored simultaneously with the content data in the storage device.

In another aspect of the invention, the reception and distribution program comprises an encryption program and a decryption program for content data, content data is received and distributed between the user terminal and the data receiving and distributing apparatus using data encrypted by the encryption program, and the user terminal and the data receiving and distributing apparatus use the decryption program to decrypt the received encrypted data for utilization. This makes it possible to provide a content receiving and distributing system that enables content to be received from or distributed to a user securely.

Preferably, the data receiving and distributing apparatus updates the reception and distribution program at predetermined intervals or as required, and distributes the updated reception and distribution program to the user terminal. This provides further security in the event the reception and distribution program is compromised.

In another aspect of the invention, the data receiving and distributing apparatus charges a user a system charge on the basis of the user's request for downloading or uploading content data. The system charge to a user includes a content-data charge, a network charge, and a charge for use of the reception and distribution program stored in the data storage means. The content-data charge is distributed to a content-managing company managing the server, the network charge is distributed to a network provider providing the network, and the reception and distribution program charge is distributed among a system-operating company operating the data receiving and distribution apparatus and one or more manufacturers involved in manufacture of the user terminal.

In yet another aspect of the invention, the user terminal is an IT apparatus that can be connected to the network and includes the storage device, a driving device containing and driving the storage device, and a main body containing the driving device. The data receiving and distributing apparatus stores predetermined ratios for distribution of the reception and distribution program charge among a first manufacturer that manufactures the storage device, a second manufacturer that manufactures the driving device, and a third manufacturer that manufactures the IT apparatus, and the reception and distribution program charge is distributed among the first to third manufacturers in accordance with the reception and distribution program charge distribution ratios. It is thus easy to promote the sale of the IT apparatus to the user. This makes it easy to expand business primarily intended to collect service charges utilizing the content receiving and distributing system of the present invention.

According to a further aspect of the invention, the first manufacturer (magnetic-disk maker) writes the reception and distribution program in the storage device in cooperation with the system-operating company. The reception and distribution program is not open. The object is to prevent the alteration of and/or interference with the reception and distribution program by a third party.

### BRIEF DESCRIPTION OF THE DRAWINGS

FIG. 1 is a diagram illustrating an example of a configuration of a content receiving and distributing system according to the present invention.

FIG. 2 is a diagram illustrating the flow of the processes performed when a user utilizing the content receiving and distributing system of the present invention downloads his or her desired content.

FIG. 3 is a diagram illustrating the flow of the processes performed if the user utilizing the content receiving and distributing system of the present invention uploads his or her desired content.

FIG. 4 is a diagram conceptually illustrating a business arrangement in the content receiving and distributing system of the present invention.

FIG. 5 is a diagram illustrating a configuration of an IT apparatus, wherein FIG. 5(a) is a diagram illustrating an example of a configuration of an IT apparatus constituting the content receiving and distributing system of the present invention, and FIG. 5(b) is a conceptual drawing of an IT apparatus adapted to record a content reception and distribution program in a semiconductor memory provided inside an HDD.

FIG. 6 is a diagram illustrating a first conventional business arrangement in which the user obtains his or her desired content, showing the flow of the process performed between a content-managing company, a content store, and the user.

FIG. 7 is a diagram illustrating the flow of consideration in the first conventional business arrangement shown in FIG. 6.

FIG. 8 is a diagram illustrating a second conventional business arrangement in which a user obtains his or her desired content, showing the flow of the process performed between a content-managing company, a network provider, and the user.

FIG. 9 is a diagram illustrating the flow of consideration in the second conventional business arrangement shown in FIG. 8.

### DETAILED DESCRIPTION OF THE PREFERRED EMBODIMENTS

Embodiments of the present invention will be described below with reference to the drawings.

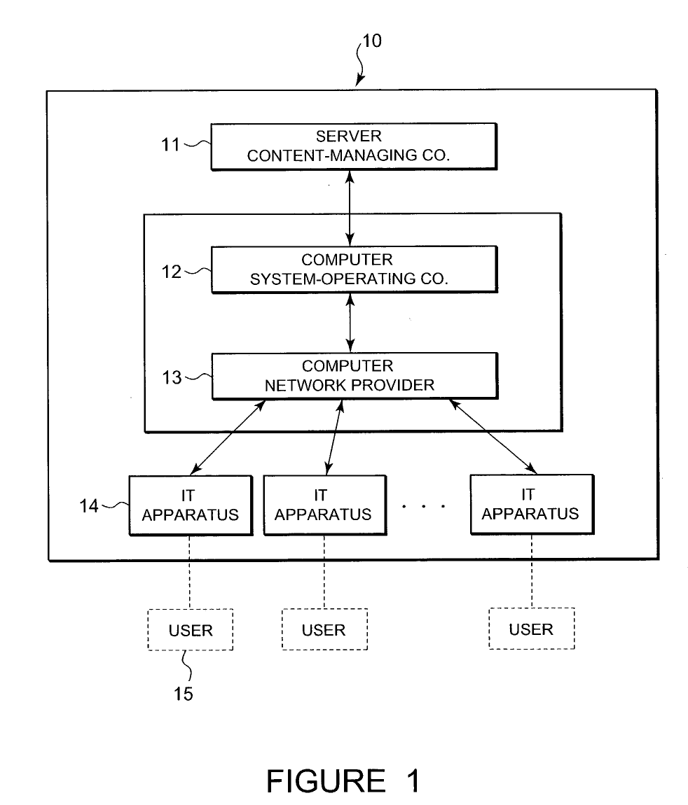

FIG. 1 is a diagram illustrating an example of a configuration of a content receiving and distributing system according to the present invention. A system 10 is includes a server 11 at a content-managing company that saves and manages original data for a variety of content, a computer 12 at a system-operating company 12 that is connected to the server 11 via a communications network, a computer 13 at a network provider that is connected to the computer 12 to provide service to a user 15, and an IT apparatus 14 such as a personal computer that is connected to the computer 13 via the communication network and acts as a terminal used by the user 15.

The IT apparatus 14 contains a recording device 16 such as a hard-disk drive device (hereinafter referred to as an “HDD”) that stores a program for receiving and distributing contents. The user 15 can utilize the present system via the IT apparatus 14 by executing this program.

In FIG. 1, the system-operating company and the network provider are different companies and comprise the computers 12 and 13, respectively. However, the system-operating company and the network provider may be the same company. In such case, a single computer may be used to perform the operations of the computers 12 and 13.

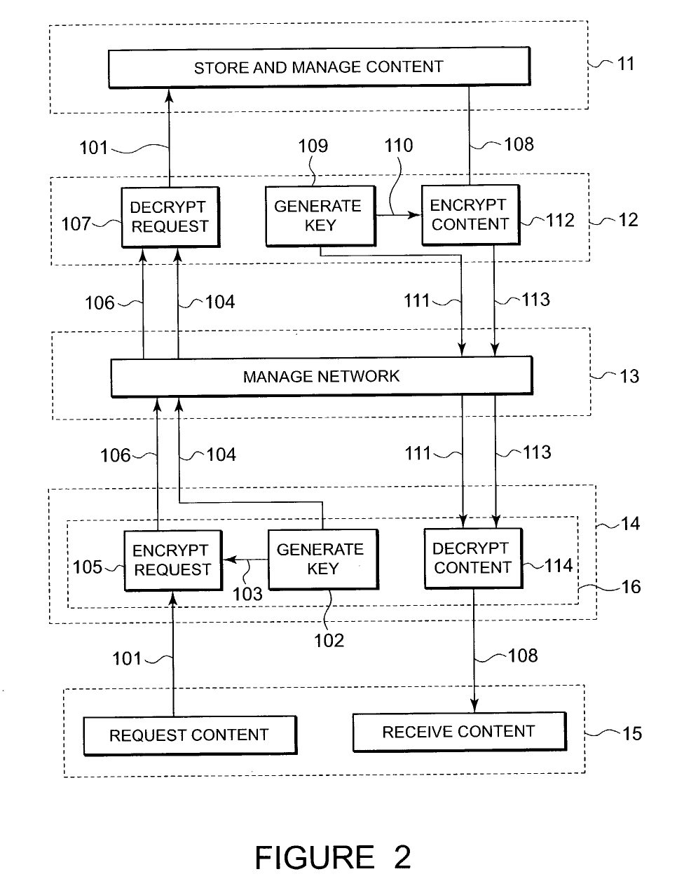

FIG. 2 is a diagram illustrating the flow of processes performed when the user utilizing the content receiving and distributing system of the present invention downloads his or her desired content. The user 15 operates an input device provided in the IT apparatus 14 to select the desired content to be downloaded and input a request command 101 to the IT apparatus 14.

The IT apparatus 14 activates a key generation program 102 recorded on the recording medium 16 to generate a secret key 103 and a public key 104. The IT apparatus 14 then uses the secret key 103 to execute an encryption process 105 for encrypting the request command 101. The IT apparatus 14 then transmits the encrypted request command 106 and the public key 104 to the system-operating company's computer 12 via the network provider's computer 13. The system-operating company's computer 12 uses the received public key 104 to execute a decryption process 107 for decrypting the encrypted request command 106 into the request command 101, which is not encrypted. The system-operating company's computer then transmits the decrypted request command 101 to the server 11 managed by the content-managing company.

The content-managing company's server 11 retrieves data for the user's desired content to be downloaded on the basis of the request command 101. The content-managing company's server 11 then transmits the data for the desired content to the system-operating company's computer 12. The computer 12 activates a previously stored key generation program for the content data to generate a secret key 110 and a public key 111. The computer 12 then uses the secret key 110 to execute an encryption process for encrypting the received content data 108. Subsequently, the computer 12 transmits the encrypted content data 113 and the public key 111 to the IT apparatus 14 of the user 15 via the network provider's computer 13.

The IT apparatus 14 uses the received public key 111 to execute a decryption process 114 for decrypting the encrypted content data 113 into original content data 108. The IT apparatus 14 then provides the content data 108 to the user.

Thus, according to the content receiving and distributing system of the present invention, the user 15 can utilize a secure content-downloading service simply by using the IT apparatus 14 to select his or her desired content to be downloaded.

In the description given in FIG. 2, the secret keys 103 and 110 differ from each other, as do the public keys 104 and 111. However, in either case, both keys may be the same.

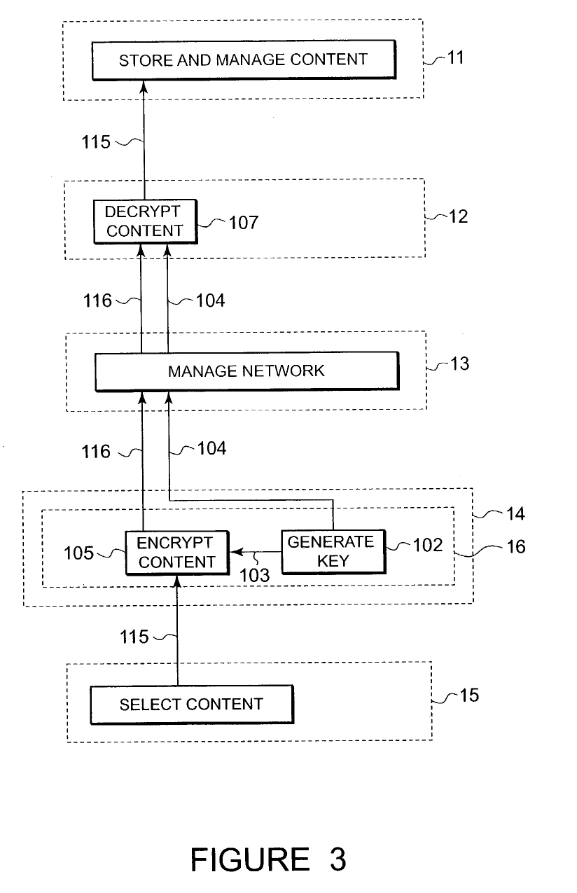

FIG. 3 is a diagram illustrating the flow of the processes performed when a user utilizing the content receiving and distributing system of the present invention, uploads content. The user 15 stores the user's selected content data 115 to be uploaded into the IT apparatus 14. The IT apparatus 14 activates the key generation program 102 recorded on the recording medium 16 contained in the IT apparatus 14 to generate the secret key 103 and the public key 104. The IT apparatus 14 then uses the secret key 103 to execute the encryption process 105 for encrypting the content data 115. The IT apparatus 14 then transmits the encrypted content data 116 and the public key 104 to the system-operating company's computer 12 via the network provider's computer 13.

The system-operating company's computer 12 uses the received public key 104 to execute the decryption process 107 for decrypting the encrypted content data 116 into content data 115 that has not been encrypted. The system-operating company's computer 12 then transmits the decrypted content data to the content-managing company's server 11.

Thus, according to the content receiving and distributing system of the present invention, the user 15 can utilize a secure content-uploading service simply by using the IT apparatus 14 to provide his or her selected content to be uploaded.

In the description given in FIG. 3, the secret key 103 and the public key 104 differ from each other. However, both keys may be the same.

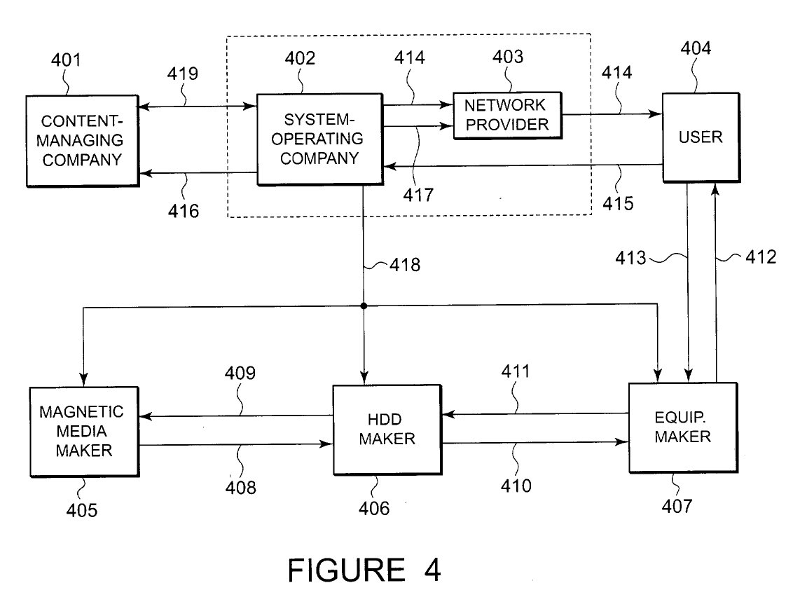

FIG. 4 is a diagram conceptually illustrating a business arrangement in the content receiving and distributing system of the present invention. In the description given in this figure, an IT apparatus used as a user terminal includes an HDD, and this recording medium is a magnetic recording medium (magnetic disk).

First, a magnetic-media maker 405 cooperates with a system-operating company 402 in the manufacture of a magnetic medium (magnetic disk) 408 on which a content reception and distribution program is magnetically recorded. The magnetic-media maker 405 then sells the magnetic medium 108 to an HDD maker 406, to obtain a consideration 409 therefor.

The HDD maker 406 manufactures an HDD 410 incorporating the magnetic medium 408 on which the content reception and distribution program is recorded. The HDD maker 406 sells the HDD 410 to an equipment maker 407, to obtain a consideration 411 therefor. The equipment maker 407 manufactures an IT apparatus 412 incorporating the HDD 410. The equipment maker 407 then sells the IT apparatus 412 to a user 404, to obtain a consideration 413 therefor. Alternately, the equipment maker 407 may lease the IT apparatus 412 to the user 404 for a charge.

The system-operating company 402 has a network provider 403 transmit content data 419 managed by a content-managing company 401, and transmit the content data 419 uploaded by the user 404. The system-operating company 402 obtains a consideration 415 for this content receiving and distributing service 414 from the user 404. Specifically, the consideration 415 includes a charge 416 for the use and storage of the content data 419, a charge 417 for the use of the network for a downloading or uploading operation, and a charge 418 for the use of the content reception and distribution program contained in the IT apparatus 412.

The consideration 415 is collected by the system-operating company 402. Then, the charge 416 for the use and storage of the content data 419 is returned to the content-managing company. The charge 417 for the use of the network is returned to the network provider 403. The charge 418 for the use of the content reception and distribution program is distributed among the system-operating company 402, the magnetic-media maker 405, the HDD maker 406, and the equipment maker 407 in a previously contracted ratio.

The use of such a profit distribution system enables each of the magnetic-media maker 405, the HDD maker 406, and the equipment maker 407 to set a lower price for its product. It is therefore easy to promote the sale of the IT apparatus 412 to the user 402. This makes it easy to expand business intended primarily to collect service charges utilizing the content receiving and distributing system of the present invention.

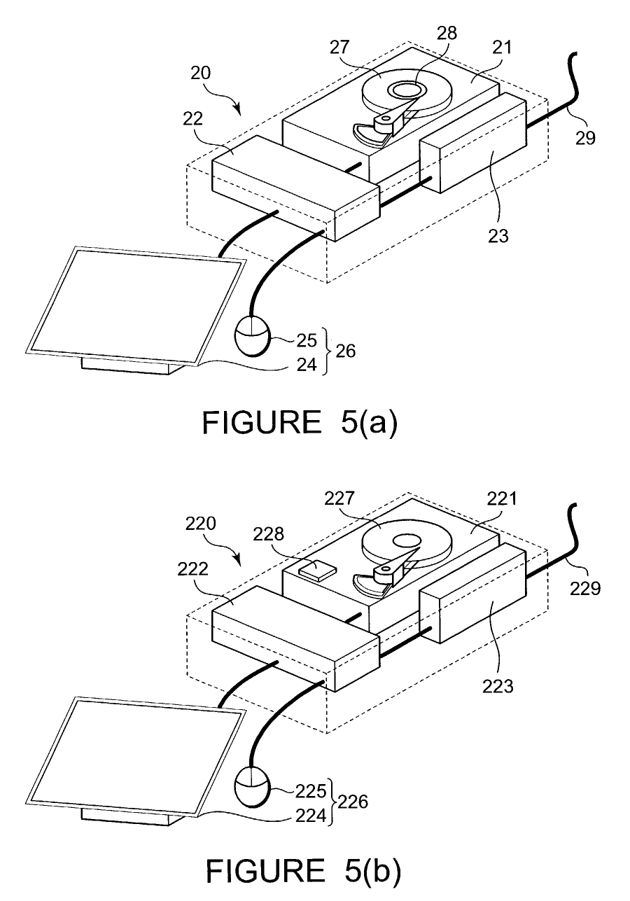

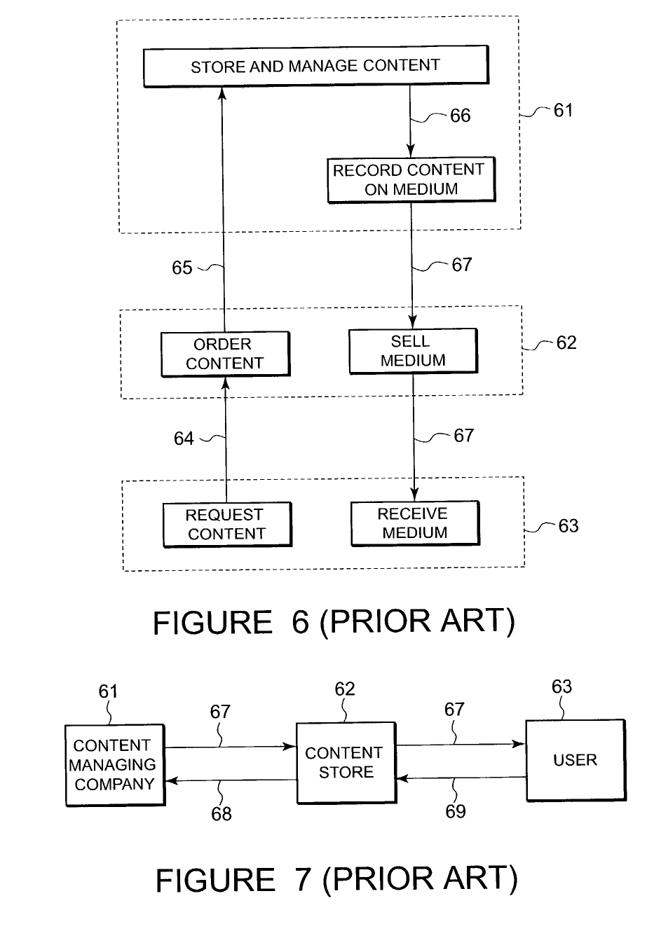

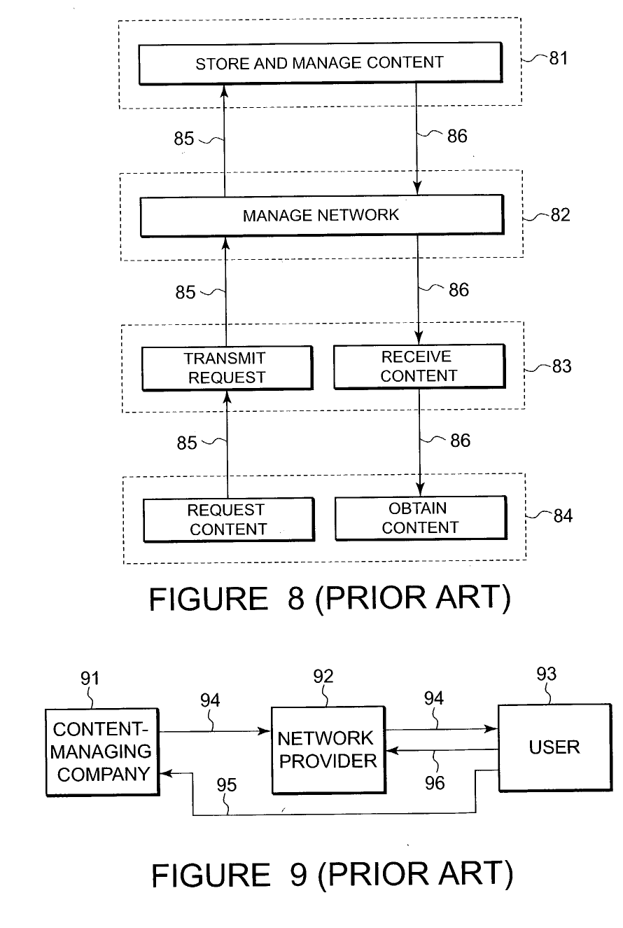

FIG. 5(a) is a diagram illustrating an example of a configuration of an IT apparatus utilized in the content receiving and distributing system of the present invention. In the description given in this figure, the IT apparatus serving as a user terminal includes an HDD, and this recording medium is a magnetic recording medium (magnetic disk).

This IT apparatus consists of a main body 20 including a main controller 22, a network interface 23 for an Ethernet™ network or the like, and an HDD 21 in which content data is stored, as well as a user interface 26 including a display 24 and a mouse 25 both connected to the main body 20. The IT apparatus is connected to a host computer owned by a network provider, via a communication-network connection line 29.

A content reception and distribution program is recorded in a part 28 of the storage area of a magnetic recording medium (magnetic disk) 27 contained in the HDD 21. This program is composed of a driver for the network interface 23 and programs (an encryption program, a decryption program, a key generation program for encryption/decryption, and a setting file for the key generation program for encryption/decryption) used to maintain security when content is received or distributed. The magnetic-media maker writes the content reception and distribution program on the magnetic recording medium in cooperation with the system-operating company.

The contents of the content reception and distribution program are not open to any third parties, including users, except for the system-operating company (and the magnetic-media maker, who has a duty of confidentiality). Only the system-operating company can set and manage the content reception and distribution program. This makes it difficult for third parties to alter, access without authorization, or commit any other malicious act upon the program.

The system-operating company frequently changes the settings of the content reception and distribution program written on the magnetic recording medium 27 in the IT apparatus 20. The system-operating company also authenticates the IT apparatus itself and the user in order to prevent a third party from posing as the user, abusing the content reception and distribution program, or committing any other malicious act upon the program. Even if the security of this system is compromised, it can be restored by changing the settings for the content reception and distribution program. This prevents further compromise of the system.

The content reception and distribution program can be rewritten by downloading a new content reception and distribution program via the network of the content receiving and distributing system according to the present invention.

In such case, the system-operating company first encrypts the new content reception and distribution program and transmits the encrypted program to the IT apparatus being utilized as a user terminal. Upon receiving the program, the IT apparatus activates the previously written content reception and distribution program. The IT apparatus decrypts and records the new content reception and distribution program on the magnetic recording medium. The IT apparatus subsequently receives service using the updated content reception and distribution program. With such a rewrite method, the content reception and distribution program itself can be rewritten, thus providing a high degree of security for uploading and downloading contents.

To write the content reception and distribution program on the magnetic medium, the magnetic media maker can use a magnetic head to write each bit of the program, as in the prior art, can use another method of collectively recording (magnetic-transfer method) an original program on the magnetic medium. The magnetic-transfer method is advantageous in that the entire program can be written in a short time. However, it is disadvantageous in that the achievable recording density is lower than that with the writing method using a magnetic head. This is due to the fact that the minimum processing size associated with an IC-process technique for producing an original is the limit of the write size, and because this size is greater than the write pitch of the magnetic head.

In this regard, the above disadvantage can be eliminated by writing the content reception and distribution program with a small capacity through magnetic transfer, and using this program to record a new content reception and distribution program with a high density. As the magnetic transfer method consists of the recording of information using a single magnetic medium, the center of rotation of the magnetic medium to which the entire program has been magnetically transferred does not necessarily coincide with the center of information (this deviation is referred to as “eccentricity”). With magnetic transfer, by recording the content reception and distribution program together with servo information, the magnitude of eccentricity can be determined on the basis of the servo information. Accordingly, the content reception and distribution program can be rewritten while the eccentricity is corrected.

The advantages of recording the content reception and distribution program on the magnetic recording medium in the IT apparatus forming a part of the content receiving and distributing system of the present invention will be described below.

First, an improper replacement can be detected. As shown in FIG. 5(a), the content reception and distribution program is contained on the magnetic recording medium 27, a basic component of the HDD 21. Then, if the IT apparatus main body 20 or the HDD 21 or magnetic recording medium 27 contained in the IT apparatus main body 20 is improperly replaced, the regular content reception and distribution program does not remain inside the IT apparatus main body 20. Accordingly, the improper replacement can be identified easily by checking the contents of the program recorded on the magnetic recording medium 27.

If on the other hand, for example, as shown in the IT apparatus in FIG. 5(b), a semiconductor memory 228 is provided inside an HDD 221 to allow the content reception and distribution program to be recorded in this memory 228, the improper replacement of the HDD 221 or the IT apparatus 220 containing the HDD 221 can be identified, as the regular content reception and distribution program does not remain after the improper replacement. However, if the magnetic recording medium 227 on which content data is recorded is improperly replaced, it is difficult to identify this improper replacement, as the regular content reception and distribution program still remains in the semiconductor memory 228.

Second, the single recording medium can simultaneously store the content reception and distribution program and content data. As the magnetic recording medium has a large capacity and a low bit cost, both the content reception and distribution program and content data can be written on the magnetic recording medium. Further, it is impossible to physically disassemble the magnetic recording medium to easily separate the content reception and distribution program from the content data. For example, it is difficult to port only the content data to another reproduction apparatus as it is.

If on the other hand, for example, as shown in FIG. 5(b), the content reception and distribution program is stored in the semiconductor memory 228 while the content data is stored on the magnetic recording medium 227, then the magnetic recording medium 227 can be physically removed by itself and used in another reproduction apparatus. This is disadvantageous.

Third, a low charge can be collected from each of the various IT apparatuses. The magnetic recording medium is a basic element of the HDD, and its cost is low. Further, a large number of magnetic recording media would be used, with at least one magnetic recording medium contained in each of the many IT apparatuses. Thus, there are many opportunities to collect charges, enabling a lower charge to be set for the use of the content reception and distribution program.

By contrast, not all IT apparatuses containing an HDD contain a semiconductor memory. Consequently, with the method of writing the content reception and distribution program in a semiconductor memory, there are few opportunities to collect the charge for the use of the content reception and distribution program. It is therefore difficult to set a low charge.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes and adaptations, and the same are intended to be comprehended within the meaning and range of equivalents of the appended claims.

What is claimed is:

1. A content receiving and distributing system comprising:
a server for storing content data;
a data receiving and distributing apparatus connected to said server; and
a user terminal for receiving content data from said server and distributing content data to said server, the user terminal being adapted for downloading content data from and uploading content data to said data receiving and distributing apparatus via a network in response to a user request; wherein:
each of said data receiving and distributing apparatus and said user terminal includes a storage means for storing a reception and distribution program required for receiving and distributing content data;
content data are simultaneously stored with said reception and distribution program in the storage means provided in said user terminal; and
said data receiving and distributing apparatus charges a user a system charge on the basis of said user's request for downloading or uploading content data.

2. The content receiving and distributing system according to claim 1, wherein:
said reception and distribution program comprises an encryption program and a decryption program for content data;
content data is received and distributed between said user terminal and said data receiving and distributing apparatus using data encrypted by the encryption program, and
said user terminal and said data receiving and distributing apparatus each use said decryption program to decrypt the received encrypted data.

3. The content receiving and distributing system according to claim 1, wherein:
said data receiving and distributing apparatus updates said reception and distribution program at predetermined intervals or as required, and distributes the updated reception and distribution program to said user terminal.

4. The content receiving and distributing system according to claim 1, wherein:
the system charge to said user is composed of a content-data charge, a network charge, and a charge for use of the reception and distribution program stored in the storage means provided in said user terminal;
said content-data charge is distributed to a content-managing company managing said server;
said network charge is distributed to a network provider providing said network, and
said charge for use of the reception and distribution program is distributed among a system-operating company operating the reception and distribution apparatus and one or more manufacturers involved in manufacture of said user terminal.

5. The content receiving and distributing system according to claim 1, wherein:
said user terminal is an IT apparatus that can be connected to said network and that includes said storage means, a driving means containing and driving the storage means, and a main body containing the driving means;
said data receiving and distributing apparatus stores predetermined ratios for distribution of the charge for use of the reception and distribution program among a first manufacturer that manufactures said storage means, a second manufacturer that manufactures said driving means, and a third manufacturer that manufactures said IT apparatus; and
the charge for use of the reception and distribution program is distributed among said first to third manufacturers in accordance with said reception and distribution program charge distribution ratios.

6. The content receiving and distributing system according to claims 5, wherein:
said first manufacturer cooperates with said network administrator in writing said reception and distribution program in said storage means, and supplying the reception and distribution program written in said storage means to said second manufacturer.

7. The content receiving and distributing system according to claim 1, wherein:
said storage means provided in said user terminal is a magnetic disk contained in a hard-disk drive device.

8. The content receiving and distributing system according to claim 1, wherein:
said reception and distribution program is not open in order to avoid alteration or interference by a third party.

9. The content receiving and distributing system according to claim 1, wherein:
said network is the Internet.
